(19) United States
(12) Patent Application Publication
(10) Pub. No.: US 2013/0063113 A1
(43) Pub. Date: Mar. 14, 2013

(54) LOAD CURRENT SENSING CIRCUIT AND METHOD

(71) Applicants: Michael Couleur, Munchen (DE); Vishal Gupta, Manchester, NH (US); Sureena Gupta, Dallas, TX (US)

(72) Inventors: Michael Couleur, Munchen (DE); Vishal Gupta, Manchester, NH (US); Sureena Gupta, Dallas, TX (US)

(73) Assignee: Texas Instruments Deutschland GmbH, Freising (DE)

(21) Appl. No.: 13/551,768

(22) Filed: Jul. 18, 2012

(30) Foreign Application Priority Data
Jul. 28, 2011 (DE) 10 2011 108 738.2

(51) Int. Cl. G05F 1/46

(52) U.S. Cl. 323/282

(57) ABSTRACT

A load current sensing circuit for sensing a DC-DC converter load current in a DC-DC converter comprising a high-side power transistor and a low-side power transistor connected in series between supply terminals and having a converter switching node therebetween coupled to an inductor to which a load is to be coupled. A first averaging stage determines a DC voltage component of the PWM signal and a second averaging stage determines a DC component of the voltage signal at the converter switching node. A comparison stage determines a difference voltage between the first averaging stage and the second averaging stage. An impedance replica stage forms a resistance which is proportional to the resistance of the series-connected power transistors. A measuring stage measures a current flowing through the impedance replica stage with the determined difference voltage applied.

### CROSS-REFERENCE TO RELATED APPLICATIONS

This patent application claims priority from German Patent Application No. 10 2011 108 738.2, filed Jul. 28, 2011, which is incorporated herein by reference in its entirety.

### FIELD OF THE INVENTION

The invention relates to a load current sensing circuit and a method.

### BACKGROUND OF THE INVENTION

In DC-DC converters, and more specifically, in switched power converters, it is difficult to sense the load current. The kind of DC-DC converters to which this invention relates typically comprise a high-side power transistor and a low-side power transistor connected in series between supply terminals. A converter switching node at the interconnection of the power transistors is adapted for connection of an inductor to which the load is connected. The power transistors are controlled by a PWM signal (pulse width modulated signal), which is generated in a PWM signal generating stage coupled to an input voltage input and applied to the gates of the power transistors via a gate driver stage. The continuous load current only flows through the inductor which is connected to the converter switching node, i.e. to the interconnection of the two power transistors. Continuous current sensing, according to the prior art, is implemented by sensing the voltage drop over the DC resistor of the inductor. However the resistance of the DC resistor is often unknown, not precisely defined and/or subject to process variation. Thus, load current sensing by sensing the voltage drop over the inductor is often very cost intensive because the customer or user needs to use inductors which have been screened for their DC resistor accuracy.

A second prior art method consists of sampling the voltage drop across one of the two power transistors at the mid-point of the switching phase which should indicate the exact load current. However, this mid-point sensing is difficult to implement, very sensitive to noise and not practical at high frequencies.

### SUMMARY OF THE INVENTION

It is a general object of the invention to provide a load current sensing circuit and a method for sensing a load current for a DC-DC converter which can easily be implemented on a chip. Furthermore, it is an object of the invention to provide a load current sensing circuit which does not necessitate screening the inductors for a suitable DC resistor, which is suitable to be used at high-switching frequency and does not require sampling of a voltage drop across a power transistor or a sense resistor.

The invention provides a load current sensing circuit. The load current sensing circuit is adapted to sense a DC-DC converter load current for a DC-DC converter which comprises a high-side power transistor and a low-side power transistor connected in series between supply terminals. A converter switching node at the interconnection of the power transistors is adapted to be coupled to an inductor to which a load is to be coupled. The power transistors are controlled by a PWM signal which is generated in a PWM signal generating stage coupled to an input voltage and applied to the gates of the power transistors.

The load current sensing circuit, according to an aspect of the invention, can then comprise a first averaging stage for determining a DC voltage component of the PWM signal which is supplied from the PWM signal generating stage. The load current sensing circuit can further comprise a second averaging stage for determining a DC component of the voltage signal at the converter switching node. In the context of this specification, the PWM signal that is averaged is assumed to alternate between ground and an input voltage level that is equal to the input voltage of the DC-DC converter. In the context of this specification, the term “averaging” relates to an average over time, for example over a full clock period of periodical signals.

The DC voltage component of the PWM signal depends on the duty cycle of the PWM signal, i.e. on the ratio between the ON time and the sum of the ON and OFF time or the duration of the high-period in relation to duration of the sum of the high-period and the low-period of the PWM signal. The high-signal value can be equal to the input voltage. The PWM signal supplied from the PWM signal generating stage is not influenced by the load.

The DC component of the voltage signal at the converter switching node equally depends on the duty cycle i.e. the ratio of the PWM signal high-period and total duration of high-period and low-period. Contrary to the PWM signal, the voltage signal at the converter switching node is a function (generally affected) by the load current. Because of the voltage drop across the ON resistance of the power transistors, the high-level and low-level of the voltage signal are not constant but have a slope.

The load current sensing circuit can further comprise a comparison stage for determining a difference voltage between the DC voltage component of the PWM signal output from the first averaging stage and the DC component of the voltage signal output from the second averaging stage. The difference voltage is due to the aforementioned voltage drop over the ON resistances of the power transistors and therefore the difference voltage depends on the load current.

The load current sensing circuit, according to aspects of the invention, may further comprise an impedance replica stage having a resistance which is a function of (for example; equal to or proportional to) the combined time averaged ON resistances of the power transistors between the two supply terminals (seen from the switching node). The previously described difference voltage may then be applied to the impedance replica stage in order to generate a current that is a function of (for example, equal to or proportional to) the load current. The combined ON resistance or combined impedance of the power transistors is the impedance that is effective at the switching node. The impedance alternates. It is either the ON resistance of the high-side power transistor or the ON resistance of the low-side power transistor. Both ON resistances can be equal, which simplifies the circuits according to the invention.

By forming a resistance which is not equal but proportional to the resistance of the series connected power transistors and by a factor K greater than the transistor combined ON resistances the replicated load current has smaller magnitude. This reduces the power consumption.

The comparison stage can be implemented by a summing amplifier. The summing amplifier can then be configured to determine the difference of the time averaged PWM signal and the time averaged voltage level at the switching node. The summing amplifier may have the following functionality. The output signal can be the amplified difference of the sum of two negative and two positive input signals according to OUT=((P1+P2)−(N1+N2))*GAIN, wherein OUT is the output signal, P1 and P2 are the positive input signals and N1 and N2 are the negative input signals and GAIN is an amplification factor. The first positive input (P1) and the first negative input (N1) may then be coupled to receive the averaged PWM signal (to P1) and the averaged switching node signal (to N1). The remaining second positive input (P2) and second negative input (N2) can be used for implementing a feedback loop in form of a voltage follower in order to apply the difference voltage (P1−N1) to the impedance replica stage in order to replicate the load current as set out above.

The load current sensing circuit may further comprise a measuring stage which is adapted to measure the current flowing through the resistance of the impedance replica stage with the determined difference voltage applied. This measuring stage may be adapted to measure the effective value of the load current or may be adapted to ensure that a certain maximum or minimum load current limit is not exceeded. All this provides that the load current can be measured by measuring a proportional DC current.

In an embodiment of the invention, the averaging stages are formed by low pass RC filters.

The resistance of the impedance replica stage is formed by a transistor that is matched to the power transistors. The gate of the transistor may then be coupled to receive a DC voltage with the same gate voltage level as the two power transistors during their respective ON states. This embodiment presumes that the two power transistors, i.e., the high-side transistor and the low-side transistor, have an identical ON resistance (identical as far as possible in a semiconductor technology).

In an embodiment, an operational amplifier can be coupled with a first input to the output of the comparison stage and with a second input and an output to the drain of the matched field-effect transistor. This provides that the drain of the matched transistor is forced to a voltage level identical to the determined difference voltage.

In another embodiment, the load current sensing circuit can further comprise a current mirror which is coupled to the drain of the matched transistor and adapted to mirror the current which flows through the matched transistor to the measuring stage. Since the ON resistance of the matched transistor is a replica of the ON resistance of the power transistors and the voltage applied to the drain is the difference voltage, the current flowing through the matched transistor is proportional to the load current. The current mirror provides that this proportional current can be measured.

If the ON resistances of the high-side power transistor and the low-side power transistor are not identical, the following embodiment of the invention can be used. In an embodiment of the invention, the load current sensing circuit comprises the load impedance replica stage comprising a first transistor matched to the high-side power transistor and a second transistor matched to the low-side power transistor. The ON resistances of the first transistor can then be similar to or a function of the ON resistance of the high-side power transistor. The ON resistance of the second transistor can then be similar to or a function of the ON resistance of the low-side transistor. The gates of the first and second transistors can then be coupled to receive signals derived from the PWM signals for the high-side and low-side transistors, respectively, in order to have the same ON-OFF behavior as the power transistors of the DC-DC converter. This aspect provides that the time averaged resistance (impedance) of the power transistors of the DC-DC converter is as effective to the switching node and is replicated in order to reproduce a current that is equal or proportional to the actual load current of the DC-DC converter.

In an embodiment of the invention, the gate of the first transistor can be coupled to the PWM signal dedicated to the high-side power transistor and the gate of the second transistor can be coupled to the inverted PWM. The two matched transistors form together the resistance of the impedance replica stage. Contrary to the first embodiment, the gates of the two transistors are not coupled to a constant DC voltage but rather to the PWM signal and the inverted PWM signal. Thus, these two transistors are switched as the power transistors. When the high-side power transistor is ON, the resistance of the first matched transistor will be considered, and when the low-side power transistor is switched ON, the resistance of the second transistor will be considered.

In the embodiment comprising two matched transistors, an operational amplifier can be coupled with a first input to the output of the comparison stage and with a second input via a low pass RC filter to the interconnected drains of the first and the second transistors.

The load current sensing circuit can comprise a current mirror coupled to the interconnected drains of the first and the second transistor and adapted to mirror the current which flows through the first and the second transistors to the measuring stage.

The invention further provides a DC-DC converter which comprises a load current sensing stage. It is to be understood that the load current sensing stage may be integrated on the same chip as the DC-DC converter.

The invention further provides a method for sensing a DC-DC converter load current in accordance with the aspects and embodiments of the invention. Accordingly, a DC voltage component of the PWM signal which is supplied from the PWM signal generating stage is determined. The PWM signal may then be assumed to toggle between the input voltage level and ground. A DC component of the voltage signal at the converter switching node is also determined The term “DC component” refers to a time average of the voltage as received by a low pass filter; for example, an RC filter. A difference voltage between the DC voltage component of the PWM signal output from the first averaging stage and the DC component of the voltage signal output from the second averaging stage is determined The determined difference voltage is applied to a resistance (impedance replica stage) which is equal to or proportional to the combined time averaged impedance (typically the resistance) of the series-connected power transistors between the two supply terminals as seen from the switching node. A current flowing through the proportional resistance is measured while the determined difference voltage is applied.

### BRIEF DESCRIPTION OF DRAWINGS

Further aspects of the invention will appear from the appending claims and from the following detailed description given with reference to the appending drawings:

FIG. 1 is a simplified circuit diagram of a DC-DC converter comprising a load current sensing circuit according to an embodiment of the invention;

FIG. 2 is a simplified diagram showing the signal waveforms of the PWM signal and the voltage signal at the switching node and in a second diagram the signal outputs of the two averaging stages according to aspects of the invention;

FIG. 3 is a simplified circuit diagram of a load current sensing circuit comprising one matched transistor according to an embodiment of the invention;

FIG. 4 is a simplified circuit diagram of a load current sensing circuit comprising two matched transistors according to an embodiment of the invention; and

FIG. 5 is simplified circuit diagram of the load current sensing circuit of FIG. 3 and the summing amplifier in more detail.

### DETAILED DESCRIPTION OF EXAMPLE EMBODIMENTS

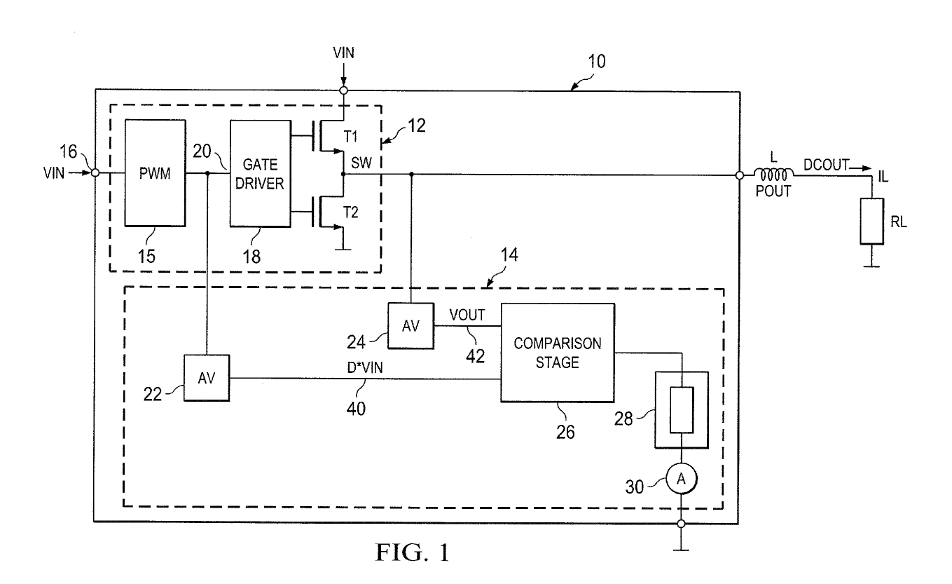

FIG. 1 is a simplified schematic of a DC-DC converter comprising a load current sensing circuit according to an embodiment of the invention. There is a circuit 10 which may be realized as an integrated circuit. Circuit 10 comprises a first stage 12 and a second stage 14.

First stage 12 comprises the DC-DC converter stages and components known to the person skilled in the art. DC-DC converter 12 comprises a PWM signal generating stage 15 which is coupled to an input voltage input 16 to which an input voltage VIN is applied. PWM signal generating stage 15 outputs a PWM signal which changes between the input voltage level VIN and a lower voltage level, e.g. ground.

The first stage 12 further comprises a gate driver stage 18 which receives at an input 20 the PWM signal generated by the PWM signal generating stage 15. Block 12 further comprises a high-side power (field-effect) transistor T1 and a low-side power (field-effect) transistor T2. T1 is connected with its drain to a voltage supply terminal to which the voltage VIN is applied. T1 is connected with its source to the drain of T2 at a converter switching node SW.

Low-side power transistor T2 is connected with its source to a second supply terminal which is connected to ground. High-side power transistor T1 receives at its gate the PWM signal output from gate driver stage 18 whereas low-side power transistor T2 receives at its gate the inverted PWM signal as output from gate driver stage 18. Switching node SW is connected to a voltage output pin POUT to which an inductor L is connected. A load RL is connected to inductor L which is represented in FIG. 1 by a resistor RL. It is to be understood that the load may also be capacitive or inductive or any combination thereof. The filtering circuitry for obtaining a DC output voltage is not shown.

Second block 14 comprises components used for load current sensing. There are a first averaging stage 22, a second averaging stage 24, a comparison stage 26, an impedance replica stage 28 and a current measuring stage 30. The first averaging stage 22 is connected with an input to the output of PWM signal generating stage 15 which is coupled to the input of gate driver stage 18 for receiving the PWM signal which is supplied from the PWM signal generating stage 15. The second averaging stage 24 is connected with an input to the converter switching node SW, i.e., the interconnection between the power transistors T1 and T2. The first averaging stage 22 and the second averaging stage 24 are connected with their respective outputs to inputs of comparison stage 26. The first averaging stage 22 provides the time averaged pulse width modulated control signal as the output signal 40 (D*VIN). The second averaging stage 24 provides the time averaged switching node signal as the output signal 42 (VOUT). Comparison stage 26 is connected with an output to impedance replica stage 28. Impedance replica stage 28 is connected to measuring stage 30.

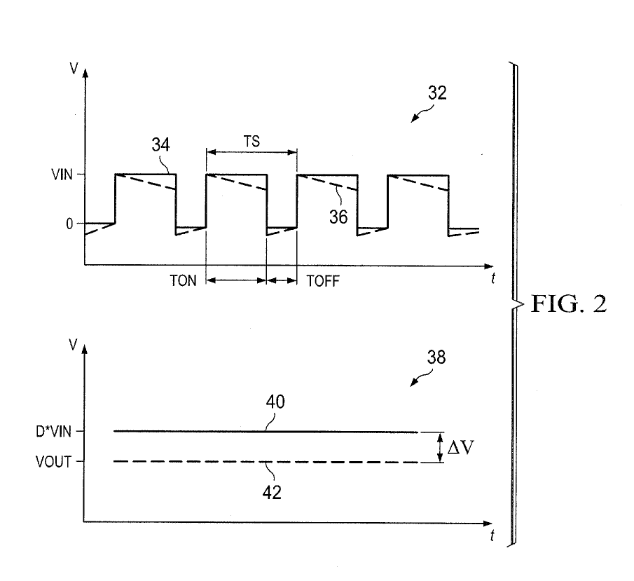

Operation of circuit 10 will be explained in connection with the diagrams of FIG. 2. FIG. 2 shows in a first diagram 32 in a line 34 the voltage level over time for the PWM signal as output from PWM signal generating stage 15, switching between a high voltage level “VIN” and a low voltage level “ground”. The PWM signal is high during a time period TON and low during a time period TOFF=T−TON. The duty cycle D is defined as D=TON/TS. A broken line 36 shows the voltage over time for the voltage signal at the converter switching node SW. PWM signal 34 changes between a high voltage level “VIN” and a low voltage level “ground”, i.e., between the same levels as changes PWM signal 34. More precisely, the high level of the voltage signal at switching node SW also starts with a voltage level VIN but then decreases with a slope. This decrease in voltage is due to the voltage drop over the ON resistance of high-side power transistor T1 and is therefore directly proportional to the load current flowing through transistor T1. The low level of the voltage signal also shows a slope. This slope is due to the voltage drop over the ON resistance of the low-side power transistor T2. Thus, it is directly proportional to the load current flowing through transistor T2.

The first averaging stage 22, as shown in FIG. 1, averages the PWM signal 34 thereby determining its DC component. The DC component is shown in the second diagram 38 of FIG. 2 as a line 40. Second averaging stage 24 as shown in FIG. 1 averages the voltage signal 36 for determining a DC component of this signal, i.e., the voltage at converter switching node SW, which results in a DC voltage shown as broken line 42 in diagram 38. The voltage level of line 40 is D*VIN, the voltage level of line 42 is VOUT.

The voltage difference between line 40 and line 42 referenced as ΔV is directly related to the load current. It is this voltage difference ΔV that is determined in comparison stage 26 in FIG. 1.

In operation, a DC input voltage VIN is applied at voltage input 16 and at the drain of transistor T1. According to the DC output voltage desired at voltage output DCOUT, PWM signal generating stage 15 outputs a PWM signal with a determined duty cycle and having a high voltage level equal the input voltage VIN. This PWM signal 34 is fed to gate driver stage 18 and to first averaging stage 22. Averaging stage 22 is adapted to average PWM signal 34 and to output the DC component 40 to comparison stage 26. Gate driver stage 18 is adapted to drive the gates of transistors T1 and T2 according to PWM signal 34 as known to the person skilled in the art. Gate driver stage 18 is in fact a power stage. Power field-effect transistors T1 and T2 switch accordingly and allow a load current to flow through converter switching node SW, voltage output pin POUT, inductor L and load RL. When transistor T1 is on and T2 is off, the voltage level at converter switching node SW is VIN and when transistor T2 is on and T1 is off, the voltage level at converter switching node SW is at ground level (0 V). Due to the inductor current, the voltage at SW can drop below ground.

Averaging stage 24 is adapted to average voltage signal 36 and to output the DC component 42 to comparison stage 26. Comparison stage 26 is adapted to determine the voltage difference ΔV between the average of the voltage at node SW and the average voltage of the PWM signal and to output it to impedance replica stage 28. For example, comparison stage 26 may be a summing amplifier using differential amplifier(s) in order to determine the voltage difference ΔV and to provide a current that is a function (for example proportional) to ΔV. The voltage difference ΔV is applied to impedance replica stage 28. The impedance of impedance replica stage 28 is a replica of (equal or proportional to) the (combined) ON resistances of power transistors T1 and T2. Therefore, a current proportional to the load current is flowing through impedance replica stage 28 and is measured in measuring stage 30.

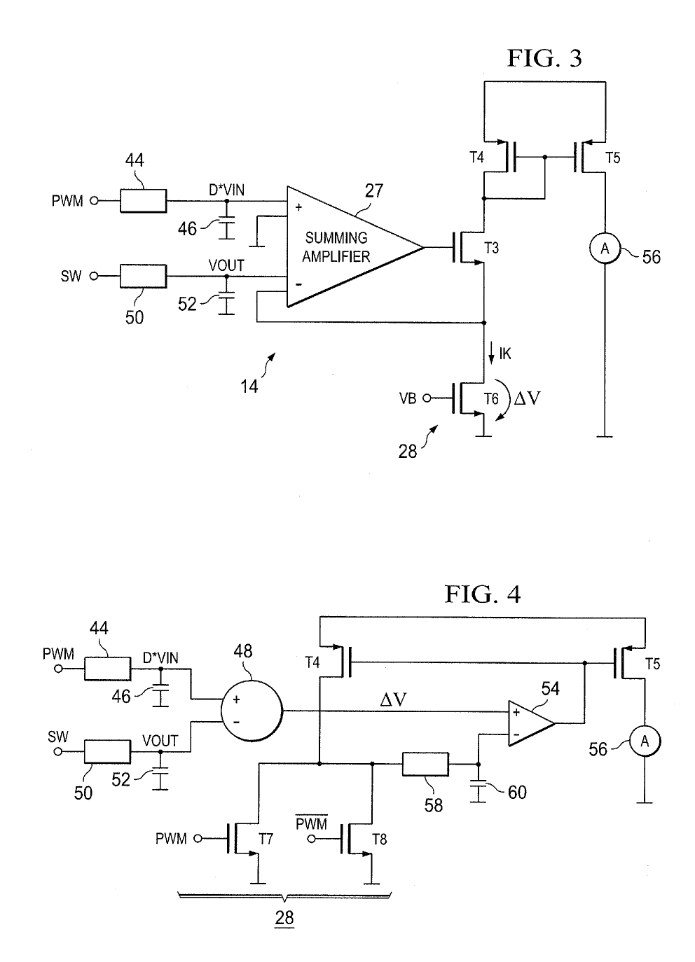

FIG. 3 shows a more detailed diagram of load current sensing circuit 14. In this embodiment, impedance replica stage 28 comprises only one transistor T6 as high-side power transistor T1 is considered to have the same ON resistance as low-side power transistor T2. A resistor 44 is connected with one terminal to the output of PWM signal generating stage 15 and with the other terminal to a capacitor 46 which is connected to ground. The interconnection node between resistor 44 and capacitor 46 is further connected to a positive input of a summing amplifier 27. Resistor 44 and capacitor 46 form a low pass RC filter corresponding to the first averaging stage 22 in FIG. 1.

A resistor 50 is connected with one terminal to converter switching node SW and with the other terminal to a capacitor 52 which is connected with its other terminal to ground. The interconnecting node between resistor 50 and capacitor 52 is connected to the negative input of summing amplifier 27. Resistor 50 and capacitor 52 form together a low pass RC filter corresponding to the second averaging stage 24 in FIG. 1.

Summing amplifier 27 corresponds to comparison stage 26 in FIG. 1. An output of summing amplifier 27 is connected to the gate of a transistor T3. The drain of transistor T3 is connected to the drain of a transistor T4 and to the gates of transistor T4 and a transistor T5. Transistors T4 and T5 are interconnected with their sources and their gates in order to form a current mirror.

The source of transistor T3 is connected to a negative input of summing amplifier 27 and to the drain of a transistor T6. Summing amplifier 27 provides a feedback loop with the source of transistor T3 and the drain of transistor T6 which are coupled to its negative input. Transistor T6 corresponds to impedance replica stage 28 of FIG. 1. Transistor T6 is matched to the power transistors T1 and T2. This means that the ON resistance of transistor T6 is equal or proportional to the combined ON resistance of the power transistors when a DC voltage with a bias voltage level VB is applied to the gate of matched transistor T6. The source of transistor T6 is connected to ground.

The drain of transistor T5 is connected to a current measuring stage 56 symbolized by the symbol of an ampere meter. It is to be understood that any known possibility to measure the current can be used in order to determine the magnitude of the current through the channel of transistor T5. This current is the replica of the load current IL.

In operation, the PWM signal as output from PWM signal generating stage 15 and represented in FIG. 2 by line 34 is averaged by the low pass filter formed by resistor 44 and capacitor 46. The averaged voltage having a voltage level 40 shown in FIG. 2 is input to a positive input of summing amplifier 27. The voltage signal at switching node SW and represented in FIG. 2 by broken line 36 is averaged by the low pass filter formed by resistor 50 and capacitor 52. The averaged voltage having a voltage level 42 is input to the negative input of summing amplifier 27. Thus the difference voltage ΔV as shown in FIG. 2 in diagram 38 is determined in summing amplifier 27, buffered and output to the gate of transistor T3.

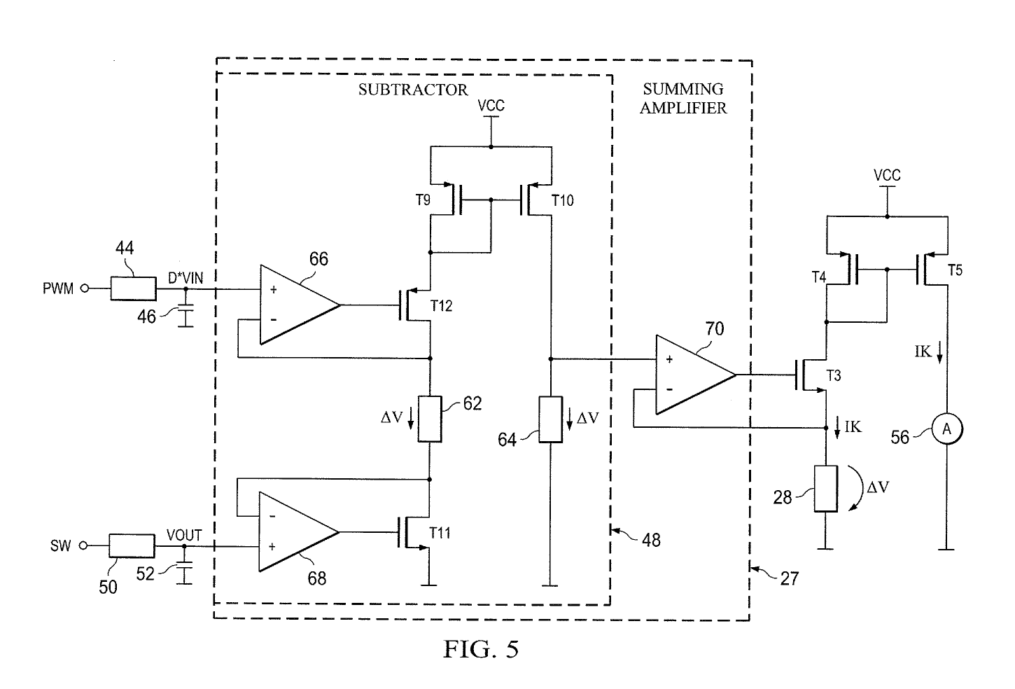

The voltage difference ΔV is determined in the summing amplifier 27 (described in more detail with respect to FIG. 5) The voltage difference ΔV, which is directly related to (is a linear function of) the load current IL is applied via the output of summing amplifier 27 and transistor T3 to the drain of transistor T6. A DC voltage with the same level as the high-level voltage of the PWM signal applied to the gates of power transistors T1 and T2, i.e., VB is applied to the gate of transistor T6 to reproduce the ON resistance of power transistors T1, T2. Therefore, the voltage difference ΔV is applied to the same ON resistance and the load current is reproduced, flowing through transistor T6.

The ON resistance of transistor T6 can differ by a factor K from the ON resistance of power transistors T1 and T2. Thus, a current IK being by the factor K flows through transistor T6 which is preferably when there are high load currents. By the current mirror formed by transistors T4 and T5 the current flowing through transistor T6 is mirrored to the measuring stage 56.

With the ON resistance rdsonH of power transistor T1 equal the ON resistance rdsonL of power transistor T2 , i.e.,

rdsonH=rdsonL=rdson
the load current may be expressed by the following formula:

$$IL = \frac{D * VIN - VOUT}{rdson}$$

wherein D is the duty cycle of phase 1 when power transistor T1 is switched on, i.e. 0<D<1, IL is the converter load current, VIN is the input voltage level, and D*VIN is the voltage level 40 of the averaged PWM signal at the positive input of summing amplifier 27, and VOUT is the voltage level 42 of the averaged voltage signal at switching node SW as input to the negative input of summing amplifier 27.

FIG. 4 shows a more detailed schematic of an embodiment of the invention in which the ON resistance of power transistor T1 is not equal to the ON resistance of power transistor T2. Therefore, the impedance replica stage 28 is realized comprising two transistors.

Similar to the embodiment of FIG. 3, there are a resistor 44 and a capacitor 46 interconnected to form a low pass filter which is connected between the PWM signal generating stage 15 and a positive input of subtracting stage 48. As in FIG. 3, a resistor 50 and a capacitor 52 are interconnected to form a low pass filter between converter switching node SW and a negative input of subtracting stage 48. Thus, as in FIG. 3, subtracting stage 48 outputs a difference voltage ΔV to operational amplifier 54. Still as in FIG. 3, an output of operational amplifier 54 is connected to the gate of a transistor T3 and transistors T4 and T5 constitute a current mirror mirroring a current to an ampere meter 56. The person skilled in the art will understand that subtracting stage 48 and operational amplifier 54 may also be realized in form of a summing amplifier 27.

In the embodiment shown in FIG. 4, the impedance replica stage 28, as shown in FIG. 1, is realized by two transistors T7 and T8. Transistor T7 is coupled with a drain to a drain of transistor T3 and with a source to ground. Transistor T7 is matched to high-side power transistor T1, i.e., the ON resistance of transistor T7 is matched to ON resistance rdsonH of transistor T1. Being matched implies that the ON resistances are coupled by a proportional factor K wherein the ON resistance of transistor T7 is preferably higher to have a smaller current to be measured. The gate of transistor T7 is coupled to receive the PWM signal as applied to the gate of power transistor T1, i.e. transistor T7 will be switched ON at the same time as and as long as transistor T1 with the same gate voltage level.

Transistor T8 is matched to the low-side power field-effect transistor T2, i.e., the ON resistance of transistor T8 is proportional to ON resistance rdsonL of transistor T2. Transistor T8 is coupled with a drain to the drain of transistor T7 and thus also to the drain of transistor T3 of the current mirror. T8 is coupled with its source to ground. The inverted PWM signal is applied to the gate of transistor T8, thus transistor T8 will be ON at the same time and for the same periods as is transistor T2 with the same gate voltage level applied.

A resistor 58 is coupled with one terminal to the interconnected drains of transistors T3, T7 and T8 and with the other terminal to a capacitor 60 and to a negative input of operational amplifier 54. Capacitor 60 is coupled with its other terminal to ground. Resistor 58 and capacitor 60 form together a low pass RC filter. Thus, the AC voltage of the switched transistors T7 and T8 is averaged to get a DC component which is fed to operational amplifier 54.

Operation of the embodiment of FIG. 4 is similar to the operation of the embodiment shown in FIG. 3. The difference voltage ΔV between the DC component of the PWM signal and the DC component of the voltage signal at converter switching node SW is forced on the drains of transistors T7 and T8 which are switched alternately. Thus, the voltage difference is always applied to an ON resistance which is proportional to the ON resistance of the switching transistors T1 and T2. Thus, the current flowing is directly related to the load current of the DC-DC converter. This current is mirrored to a measuring stage 56 and allows thus measurement of the load current without the need of sampling a voltage and without the need to select an inductor L for a specific DC resistance. In this case, the load current can be expressed by the following formula:

$$IL = \frac{D * VIN - VOUT}{rdsonL ( 1 - D ) + rdsonH * D}$$

The current flowing through the replica impedance is then the load current. If the replica impedance is K times larger than the actual power FET time average impedance, the current measured across the replica impedance will be K times smaller than the load current which is desired when working with high load currents. Again, there is a feedback loop via operational amplifier 54.

The proposed solution uses the DC voltage difference between the internal PWM signal and the converter external SW pin to determinate the load current. The SW pin being defined as the point where the two power FETs connect to the inductor. The DC voltage of the SW pin when averaged out is equal to the DC voltage of the internal PWM signal when averaged out minus the load current times the time average resistance seen across the FETs.

FIG. 5 shows another embodiment of the current sensing stage. The circuit shown in FIG. 5 is similar to the embodiment of FIG. 3. However, the summing amplifier is now shown in more detail.

The subtracting stage 48 can be implemented by two operational amplifiers 66 and 68, the four transistors T9, T10, T11 and T12 and the two resistors 62 and 64. The averaged input signal VOUT derived from switching node SW is fed to the positive input of operational amplifier 68. The averaged input signal D*VIIN derived from switching the PWM signal is fed to the positive input of operational amplifier 66. The output of operational amplifier 68 is coupled to the gate of transistor T11. The output of operational amplifier 66 is coupled to the gate of transistor T12. The negative input of operational amplifier 68 is coupled to the first side of resistor 62 and to the drain of transistor T11 (NMOS transistor). The negative input of operational amplifier 66 is coupled to the second side of resistor 62 and to the drain of transistor T12 (PMOS transistor). T9 and T10 are configured as a current mirror, the input of which is coupled to the source of transistor T12. This provides that the difference voltage ΔV is applied across resistor 62. Accordingly, a current that is proportional to IL is then fed through resistor 62 from there mirrored through resistor 64. The summing amplifier 27 is completed by a voltage follower implemented by operational amplifier 70 being coupled with its output to the gate of transistor T3. The negative input of operational amplifier 70 is coupled between the source of T3 and the impedance replica stage 28. Accordingly, the difference voltage ΔV is applied across impedance replica stage 28 and a replica IK of the load current is generated that is mirrored through current mirror T4, T5 to any measuring mechanism 56 that determines the magnitude and/or the changes of the replica current IK and serves therefore as an indicator of the load current IL.

The current IK is a linear function of (proportional to) the load current but has a much smaller magnitude in order to save power.

Although the invention has been described in detail, it should be understood that various changes, substitutions and alterations, may be made thereto without departing from the spirit or scope of the invention as defined by the appended claims.

1. A load current sensing circuit for sensing a DC-DC converter load current of a DC-DC converter comprising a high-side power transistor and a low-side power transistor connected in series between supply terminals, a converter switching node at the interconnection of the power transistors being adapted to be coupled to an inductor to which a load is to be coupled, the power transistors being controlled by a PWM signal, which is generated in a PWM signal generating stage coupled to an input voltage input and applied to the gates of the power transistors;
the load current sensing circuit comprising:
a first averaging stage for determining a DC voltage component of the PWM signal which is supplied from the PWM signal generating stage to the gate driver stage;
a second averaging stage for determining a DC component of the voltage signal at the converter switching node;
a comparison stage for determining a difference voltage of the DC voltage component of the PWM signal output from the first averaging stage and the DC component of the voltage signal output from the second averaging stage;
an impedance replica stage forming a resistance which is proportional to the time averaged resistance of the series-connected power transistors between the two supply terminals seen from the converter switching node and to which the determined difference voltage is applied, and
a measuring stage adapted to measure a current flowing through the resistance of the impedance replica stage with the determined difference voltage applied.

2. The load current sensing circuit according to claim 1, wherein the resistance of the impedance replica stage is formed by a transistor matched to the power transistors, the gate of the transistor being coupled to receive the same gate voltage level as applied to the gates of the power transistors for operating the transistors.

3. The load current sensing circuit according to claim 1, wherein the resistance of the impedance replica stage is formed by a first transistor matched to the high-side power transistor and a second transistor matched to the low-side power transistor, the gates of the first transistor being coupled to the PWM signal and the second transistor being coupled to the complementary signal of the PWM signal in accordance with the switching of the power transistors for replicating the combined On resistance of the power transistors.

4. The load current sensing circuit according to claim 2, wherein the resistance of the impedance replica stage is formed by a first transistor matched to the high-side power transistor and a second transistor matched to the low-side power transistor, the gates of the first transistor being coupled to the PWM signal and the second transistor being coupled to the complementary signal of the PWM signal in accordance with the switching of the power transistors for replicating the combined On resistance of the power transistors.

5. A DC-DC converter comprising a high-side power transistor and a low- side power transistor connected in series between supply terminals, a converter switching node at the interconnection of the power transistors being adapted to be coupled to an inductor to which a load is to be connected, the power transistors being controlled by a PWM signal, which is generated in a PWM signal generating stage coupled to an input voltage input and applied to the gates of the power transistors, further comprising load current sensing circuit comprising:
a first averaging stage for determining a DC voltage component of the PWM signal which is supplied from the PWM signal generating stage to the gate driver stage;
a second averaging stage for determining a DC component of the voltage signal at the converter switching node;
a comparison stage for determining a difference voltage of the DC voltage component of the PWM signal output from the first averaging stage and the DC component of the voltage signal output from the second averaging stage;
an impedance replica stage forming a resistance which is proportional to the time averaged resistance of the series-connected power transistors between the two supply terminals seen from the converter switching node and to which the determined difference voltage is applied, and
a measuring stage adapted to measure a current flowing through the resistance of the impedance replica stage with the determined difference voltage applied.

6. The load current sensing circuit according to claim 5, wherein the resistance of the impedance replica stage is formed by a transistor matched to the power transistors, the gate of the transistor being coupled to receive the same gate voltage level as applied to the gates of the power transistors for operating the transistors.

7. The load current sensing circuit according to claim 5, wherein the resistance of the impedance replica stage is formed by a first transistor matched to the high-side power transistor and a second transistor matched to the low-side power transistor, the gates of the first transistor being coupled to the PWM signal and the second transistor being coupled to the complementary signal of the PWM signal in accordance with the switching of the power transistors for replicating the combined On resistance of the power transistors.

8. A method for sensing a DC-DC converter load current of a DC-DC converter comprising a high-side power transistor and a low-side power transistor connected in series between supply terminals, a converter switching node at the interconnection of the power transistors being adapted to be coupled to an inductor to which a load is to be coupled, the power transistors being controlled by a PWM signal, which is generated in a PWM signal generating stage coupled to an input voltage input and applied to the gates of the power transistors;
the method comprising
determining a DC voltage component of the PWM signal which is supplied from the PWM signal generating stage to the gate driver stage;
determining a DC component of the voltage signal at the converter switching node;
determining a difference voltage between the DC voltage component of the PWM signal output from the first averaging stage and the DC component of the voltage signal output from the second averaging stage;
applying the determined difference voltage to a resistance that is proportional to the time averaged resistance of the power transistors as effective to the switching node;
measuring a current flowing through the proportional resistance while the determined difference voltage is applied.

9. The method of claim 7, wherein the applying step applies the difference voltage across an impedance replica stage formed by a transistor matched to the power transistors, the gate of the transistor being coupled to receive the same gate voltage level as applied to the gates of the power transistors for operating the transistors.

10. The method of claim 7, wherein the applying step applies the difference voltage across an impedance replica stage formed by a first transistor matched to the high-side power transistor and a second transistor matched to the low-side power transistor, the gates of the first transistor being coupled to the PWM signal and the second transistor being coupled to the complementary signal of the PWM signal in accordance with the switching of the power transistors for replicating the combined On resistance of the power transistors.
